(19) United States
(12) Patent Application Publication
(10) Pub. No.: US 2006/0132288 A1
(43) Pub. Date: Jun. 22, 2006

(54) Method of reading information from RF tag and method of writing information therein

(75) Inventors: Tadahiko Hirai, Ohta-ku (JP); Keiichi Murai, Kashiwa-shi (JP); Kikuzo Sawada, Koganei-shi (JP)

Correspondence Address: Canon U.S.A. Inc.;Intellectual Property Department, 15975 Alton Parkway, Irvine, CA, 92618-3731, US

(73) Assignee: Canon Kabushiki Kaisha, Ohta-ku (JP)

(21) Appl. No.: 11/286,640

(22) Filed: Nov. 23, 2005

(30) Foreign Application Priority Data
Nov. 30, 2004 (JP) 2004-345839

(51) Int. Cl. H04Q 5/22

(52) U.S. Cl. 340/10.4; 340/572.5; 340/10.51

(57) ABSTRACT

A method of reading information from and writing information onto an RF tag that resonates by electromagnetic inductance, the RF tag including at least two sets of electromagnetic resonance circuits having mutually different resonance frequencies, the at least two sets of electromagnetic resonance circuits having at least one of a resistor and a capacitor, a fuse or antifuse element capable of selecting a low impedance state and a high impedance state on the basis of an electrical signal, and a coil antenna, is provided.

### BACKGROUND OF THE INVENTION

1. Field of the Invention

The present invention relates to a method of reading information from an inexpensive non-contact RF tag that does not use expensive parts such as LSI chips and to a method of writing information therein.

2. Description of the Related Art

Hitherto, in the field of non-contact tags, the technique for optically reading a bar code has been the most popular, and these types of tags have been installed on all kinds of products. Since bar codes are very inexpensive and enable tags to be compliant with a networked settlement system, bar codes have been used in stock control and distribution management. However, since bar codes are optically read, they are vulnerable to dust. In addition, they also have the problem of not including additional recording characteristics and of containing a small amount of storage information.

In recent years, non-contact RF (Radio Frequency) tags and cards that use a semiconductor integrated circuit LSI (large-scale integrated circuit) have become popular. These tags and cards have an information capacity larger than that of bar codes and are not susceptible to dust. Furthermore, since additional information can be recorded on these tags and cards, they provide excellent traceability and tracking features. However, two drawbacks to using these types of tags and cards are that they are more expensive than bar codes and cannot be used over large distances.

Japanese Patent Laid-Open No. 8-44794 (U.S. Pat. No. 5,522,509) describes a resonance tag (RF tag) having an LC resonance circuit. Japanese Patent Laid-Open No. 11-96326 describes a method of reading information for specifying the resonance frequency of arrayed tags in which a plurality of RF tags are arranged. These RF tags are also not susceptible to dust, but less expensive than the non-contact RF tags that use an LSI. Neither of these documents, however, describes a method in which additional information can be recorded.

Japanese Patent Laid-Open No. 2003-271912 describes an ID tag for indicating specific information by the frequency difference or the frequency ratio of another frequency to the frequency serving as a reference among frequencies of resonance waves. Rewriting of a resonance frequency due to dielectric breakdown of a capacitor is also described. Japanese Patent Laid-Open No. 11-175650 describes that reference waveform pattern data is stored in a memory of a reflected wave analysis device of an LC resonance tag.

### SUMMARY OF THE INVENTION

In view of the above, the present invention is capable of consistently reading information from and consistently recording additional information onto a resonance tag (RF tag) where the resonance tag is less susceptible to dust and less expensive than a non-contact RF tag that uses an LSI.

The present invention provides a method of reading information from an RF tag that resonates by electromagnetic inductance, the RF tag including at least two sets of electromagnetic resonance circuits having mutually different resonance frequencies, the at least two sets of electromagnetic resonance circuits having at least one of a resistor and a capacitor, a fuse or antifuse element capable of selecting a low impedance state and a high impedance state on the basis of an electrical signal, and a coil antenna, the method including transmitting a plurality of frequencies to the RF tag, receiving a plurality of reflected waves corresponding to the mutually different resonance frequencies of the at least two sets of electromagnetic resonance circuits in response to the transmitted plurality of frequencies, and detecting a relative relationship of the mutually different resonance frequencies of the plurality of reflected waves.

A detection of the relative relationship of the mutually different frequencies of the plurality of reflected waves is performed by detecting a frequency difference between a reference reflected wave corresponding to a resonance frequency of a reference electromagnetic resonance circuit provided in advance in the RF tag and the plurality of reflected waves.

A detection of the relative relationship of the mutually different resonance frequencies of the plurality of reflected waves is performed by converting the relationship of the mutually different resonance frequencies of the plurality of reflected waves into an approximate function, and comparing the approximate function with a function provided in advance.

A detection of the relative relationship of the mutually different resonance frequencies of the plurality of reflected waves is performed by converting the relationship of the mutually different resonance frequencies of the plurality of reflected waves into a graph, and comparing the graph with a graph provided in advance.

The present invention provides a method of writing information into an RF tag that resonates by electromagnetic inductance, the RF tag including at least two sets of electromagnetic resonance circuits having mutually different resonance frequencies, the at least two sets of electromagnetic resonance circuits having at least one of a resistor and a capacitor, a fuse or antifuse element capable of selecting a low impedance state and a high impedance state on the basis of an electrical signal, and a coil antenna, the method including reading information from the RF tag by measuring the mutually different resonance frequencies of the at least two sets of electromagnetic resonance circuits, transmitting a plurality of frequencies to the RF tag, receiving, in response to the transmitted plurality of frequencies, a plurality of reflected waves corresponding to the mutually different resonance frequencies of the at least two sets of electromagnetic resonance circuits, and detecting a relative relationship of the mutually different resonance frequencies of the plurality of reflected waves, and irradiating an electromagnetic wave matching a resonance frequency of at least one of the at least two sets of electromagnetic resonance circuits, the irradiated electromagnetic wave having a larger amplitude than an electromagnetic wave associated with the reading of information, in order to change the impedance of the fuse or the antifuse forming the at least one of the at least two sets of electromagnetic resonance circuits so that a resonance frequency of at least one desired electromagnetic wave resonance circuit is changed.

Further features of the present invention will become apparent from the following description of exemplary embodiments with reference to the attached drawings.

### BRIEF DESCRIPTION OF THE DRAWINGS

FIG. 1 shows the structure of an RF tag according to a first embodiment of the present invention.

FIG. 2 is a graph illustrating characteristics of an antifuse, which is a constituent of an electromagnetic resonance unit of the RF tag according to the first embodiment of the present invention.

FIG. 3 is a schematic diagram showing a system including the RF tag according to the first embodiment of the present invention.

FIG. 4 is a graph showing a technique for analyzing reflected waves according to the first embodiment of the present invention.

FIG. 5 is a graph showing a technique for analyzing reflected waves according to the first embodiment of the present invention.

FIGS. 6A and 6B are graphs showing techniques for analyzing reflected waves according to a second embodiment of the present invention.

### DESCRIPTION OF THE EMBODIMENTS

According to a method of reading information from an RF tag according to an embodiment of the present invention, in an inexpensive RF tag that is less susceptible to dust than tags such as bar codes and does not use expensive parts such as LSI chips, a relative relationship of mutually different resonance frequencies of a plurality of reflected waves corresponding to the mutually different resonance frequencies of at least two sets of electromagnetic resonance circuits is detected. Therefore, even if mutually different resonance frequencies of the at least two sets of electromagnetic resonance circuits vary for each RF tag, if the relative relationship of the mutually different resonance frequencies of the at least two sets of electromagnetic resonance circuits in the same tag is maintained, consistent information reading can be performed.

When the detection of the relative relationship of the mutually different resonance frequencies of a plurality of reflected waves is performed by detecting the difference between the frequency of a reference reflected wave corresponding to a resonance frequency of a reference electromagnetic resonance circuit that is provided in advance in the RF tag and the frequency of the plurality of reflected waves, consistent information reading can be performed by a simple operation of estimating the frequency difference between the reference reflected wave and the plurality of reflected waves.

When the detection of the relative relationship of the mutually different resonance frequencies of the plurality of reflected waves is performed by converting the relationship of the mutually different resonance frequencies of the plurality of reflected waves into an approximate function and comparing the approximate function with a function provided in advance, consistent information reading can be performed by a simple operation of comparing the coefficients of the two functions.

When the detection of the relative relationship of the mutually different resonance frequencies of the plurality of reflected waves is performed by converting the relationship of the mutually different resonance frequencies of the plurality of reflected waves into a graph and comparing the graph with a graph provided in advance, consistent information reading can be performed by a simple operation of comparing images and data of the two graphs.

According to a method of writing information into an RF tag according to the embodiment of the present invention, consistent additional recording (rewriting) of information can be performed by changing the resonance frequency of at least one of the at least two sets of electromagnetic resonance circuits by changing the impedance of a fuse or an antifuse, thus forming at least one desired electromagnetic resonance circuit.

The present invention is concerned with a method of reading and writing information from and into an RF tag that can store, read, and record an additional plurality of bits of information without using expensive parts such as LSI chips.

The term “RF” in this specification refers to a radio frequency and also refers to electromagnetic waves that can be propagated in the space. The term “tag” refers to a card-shaped label, a certification tag, etc.

The RF tag according to the embodiment of the present invention includes at least two sets of electromagnetic resonance circuits having mutually different resonance frequencies, the at least two sets of electromagnetic resonance circuits having at least one of a resistor and a capacitor, a fuse or antifuse element capable of selecting a low impedance state and a high impedance state on the basis of an electrical signal, and a coil antenna.

The specific resonance frequency for each of the at least two sets of electromagnetic resonance circuits is determined by a combination of wiring, the resistance value of the resistor, the capacitance of the capacitor, and the inductance of the coil antenna. As a result of the at least two sets of electromagnetic resonance circuits having different resonance frequencies existing in the same tag, a plurality of pieces of information can be recorded. The information to be stored is determined by the combination of the resonance frequencies of the at least two sets of electromagnetic resonance circuits.

As described above, in the method of reading information from an RF tag according to the embodiment of the present invention, a plurality of frequencies is transmitted to the RF tag, a plurality of reflected waves corresponding to mutually different resonance frequencies of at least two sets of electromagnetic resonance circuits is received, and a relative relationship of the mutually different resonance frequencies of the plurality of reflected waves is detected. Thus, rather than directly reading information on the basis of the frequency of the plurality of reflected waves, the relative relationship of the mutually different resonance frequencies of the plurality of reflected waves is detected, and on the basis of this relationship, information is read. As a result, even if the mutually different resonance frequencies of the at least two sets of electromagnetic resonance circuits shift due to, for example, manufacturing variations in RF tags, this does not affect the reading operation, and therefore, consistent information reading can be performed.

Since the RF tag according to the present invention includes a fuse or antifuse element capable of selecting a low impedance state and a high impedance state on the basis of an electrical signal in each of the RF tag's electromagnetic resonance circuits, the resonance frequency of each of the electromagnetic circuits can be changed or resonated by an externally irradiated electromagnetic wave. This makes it possible to electrically rewrite information from the outside. The fuse or antifuse can also function as a resistor or a capacitor. The fuse is a resistor by itself and has a low resistance in the initial state. As a result of causing a large electrical current to flow, a state change occurs, and the fuse shifts to a high resistance state. In comparison, the antifuse is a capacitor by itself and has a high resistance in the initial state. As a result of applying a high voltage, a state change occurs, and the antifuse shifts to a low resistance state.

In the method of writing information into an RF tag according to the present invention, after information is read by the information reading method according to the present invention, the resonance frequency of at least one desired electromagnetic resonance circuit is changed. This is performed by irradiating an electromagnetic wave having a larger amplitude than an electromagnetic wave associated with reading information, which matches the resonance frequency of the at least one electromagnetic resonance circuit to be changed, in order to change the impedance of the fuse or the antifuse having the above-described characteristics, which forms the at least one electromagnetic resonance circuit to be changed. Therefore, consistent additional recording (rewriting) of information can be performed.

Exemplary embodiments of the present invention will be described below with reference to the drawings.

### First Embodiment

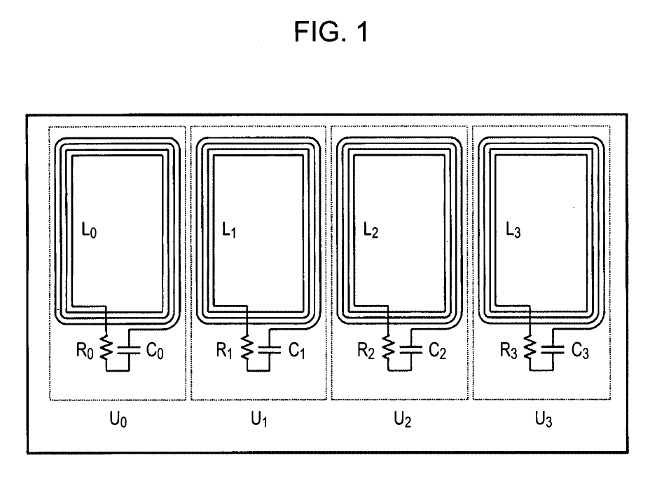

FIG. 1 shows the configuration of an RF tag according to the first embodiment. Four sets of electromagnetic resonance circuit units (U₀ to U₃) including one resistor (R₀ to R₃), one capacitor (C₀ to C₃), and one coil antenna (L₀ to L₃) are formed on a plastic substrate, thereby forming one RF tag. The resonance frequency bands of each unit are separated from one another.

The electromagnetic resonance unit U₀ is a reference electromagnetic resonance circuit and has a fixed reference resonance frequency.

The electromagnetic resonance units U₁, U₂, and U₃ correspond to the place of 1, the place of 2, and the place of 2² in the binary notation, respectively. For the resonance frequency of each electromagnetic resonance unit, a binary resonance frequency can be selected for each unit by selecting either of the larger or smaller capacity (binary value) of the capacitor contained in each unit. More specifically, the capacitors contained in the electromagnetic resonance unit U₁, U₂, and U₃ have an antifuse element function, and have a high resistance and a large capacitance in the initial state. After the state is changed, they have a low resistance and a small capacitance. By applying a large voltage to the antifuse, the state can be changed.

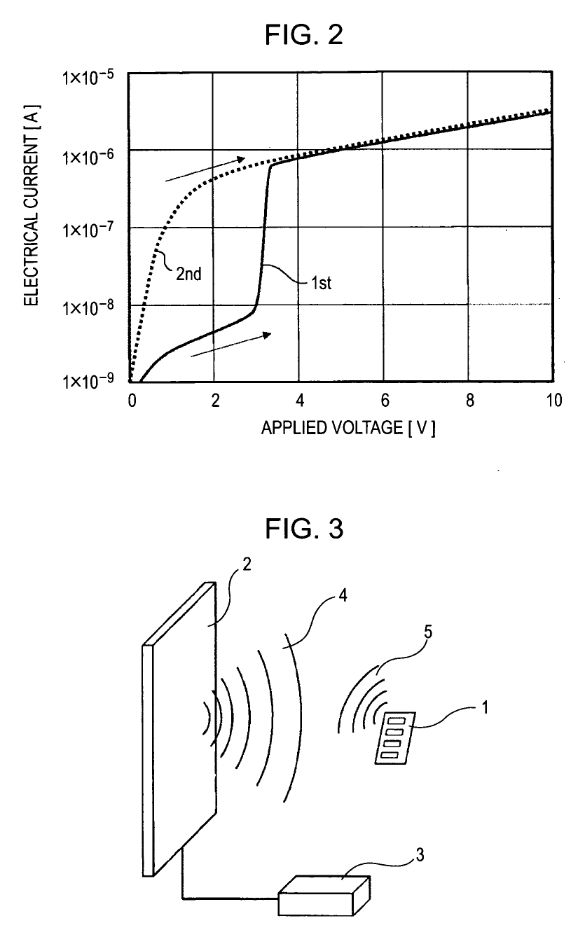

FIG. 2 shows DC electrical characteristics of a single antifuse. It can be seen that, as a result of a first voltage scan, the electrical current value sharply increases in the vicinity of 3 V, and the state has shifted from a high impedance (high resistance) state to a low impedance (low resistance) state. It can be seen that, in a second voltage scan, the low impedance state is maintained.

When such an antifuse is used in the electromagnetic resonance circuit, if the RF peak value of the resonance frequency is made sufficiently greater, the antifuse breaks down, and the resonance frequency of the electromagnetic resonance circuit shifts. Furthermore, the antifuse is short-circuited in an irreversible manner, and the resonance frequency varies. Therefore, information is written (additionally recorded) stably.

FIG. 3 shows an example of a system in which an RF tag and a reading device are combined. The system includes an RF tag 1, a reading antenna 2, and a reading device 3. A read electromagnetic wave 4 emitted from the reading antenna 1 resonates with the RF tag, causing a reflected wave 5 to be generated. This reflected wave is received by the reading antenna 2, and the reflected wave is analyzed by the reading device 3 in order to obtain information stored in the RF tag 1. In some instances, the read electromagnetic wave 4 emitted from the reading antenna 1 is absorbed by the RF tag instead of causing a reflected wave 5 to be generated.

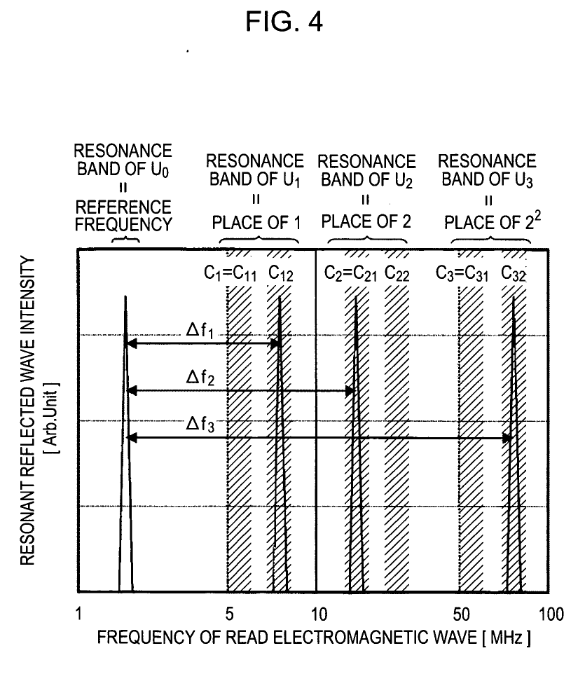

FIG. 4 is a graph showing the frequency of the read electromagnetic wave emitted from the reading antenna and the intensity of the reflected wave in order to show an example of a reflected wave analysis technique in the reading device 3. In FIG. 4, the resonance frequency bands of the units U_{1 to U}₃ are shown, and also binary resonance frequencies corresponding to the largeness or smallness (for example, C₁₁ and C₁₂ in the case of U₁) of the capacity of the capacitor contained in each unit are shown. For example, in the case of U₁, the resonance frequency corresponding to C₁₁ corresponds to “0” at the place of 1, and the resonance frequency corresponding to C₁₂ corresponds to “1” at the place of 1. Therefore, in the case of FIG. 4, “101” is shown in the binary notation.

In this embodiment, in order to identify the reflected wave frequency position, the reflected wave frequency is identified by measuring frequency differences Δf₁, Δf₂, and Δf₃ with the reference reflected wave frequency rather than using an absolute frequency value. As a result, even if the resonance frequency shifts due to manufacturing variations in RF tags, there is the advantage in that the reading operation is not affected.

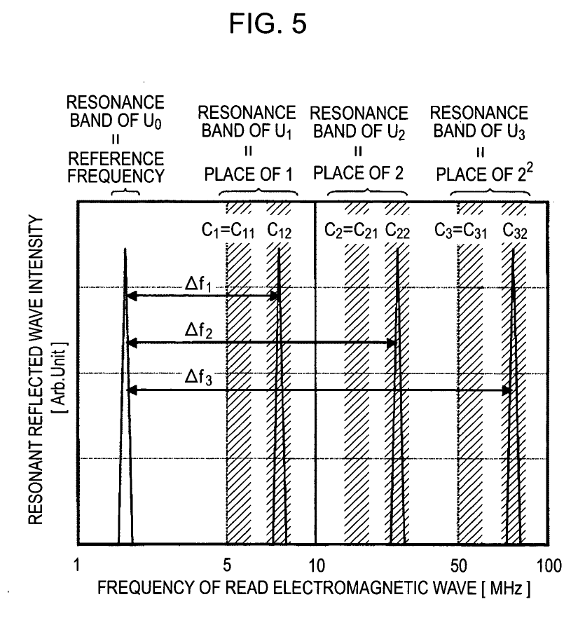

FIG. 5 shows a state after an RF electromagnetic wave having a larger amplitude than that during reading is irradiated in accordance with the resonance frequency of U₂. It can be seen that the state of the antifuse is changed and that the resonance frequency of U₂ is changed. As a result, the recorded information has become “111”. This means that the additional recording of information is made possible.

In order to determine the resonance frequency of each unit, it is necessary to determine the resistance value of the resistor, the capacity of the capacitor, and the inductance of the coil. However, the resistor or the capacitor can be omitted, and a plurality of resistors, capacitors, and coils can be incorporated.

As a means for selecting the resonance frequency of each unit, in the present embodiment, the largeness or smallness of the capacitor is selected. Alternatively, the largeness or smallness of the resistance value of the resistor and the inductance value of the coil can be selected. In addition, not only can a binary value be selected, but also a ternary or higher value can be selected.

It is also possible to use a fuse element also serving the function of a resistor without using an antifuse.

### Second Embodiment

The RF tag in the second embodiment is similar to that of the first embodiment. The RF tag in the present embodiment, however, does not have a reference electromagnetic resonance circuit. Four sets of electromagnetic resonance circuit units correspond to the place of 1, the place of 2, the place of 2², and the place of 2³ in the binary notation, respectively. For the resonance frequency of each electromagnetic resonance unit, by selecting either of the larger or smaller capacity (binary value) of the capacitor contained in each unit, a resonance frequency of a binary value can be selected for each unit.

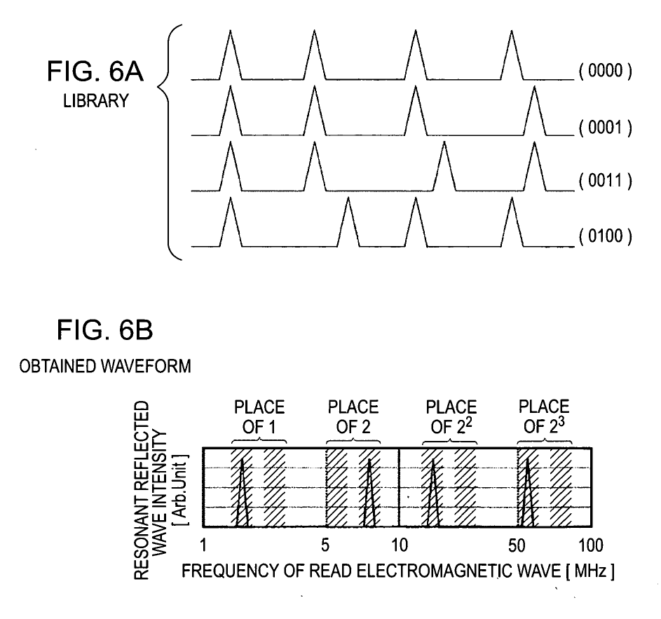

The technique for analyzing a reflected wave in the present embodiment is a technique in which a peak shape (graph) of a plurality of obtained reflected waves is compared with a waveform library (graph) provided in advance as shown in FIG. 6A, and the reflected wave is determined as the same information as the nearest library.

In an example, when a plurality of reflected waves as shown in FIG. 6B are obtained, the reflected wave is the information of (0100) in FIG. 6A, which shows a waveform closest to the peak waveform.

As described above, in the present embodiment, a plurality of reflected waves are converted into a graph, and the graph is compared with a graph provided in advance in order to identify the reflected wave frequency position. In addition, there is a known method in which the relationship of mutually different resonance frequencies of the reflected waves is converted into an approximate function and the approximate function is compared with a function provided in advance, a known method of extracting a point at which the variation width is large, a known method in which image recognition is performed to make a comparison, and other methods.

Examples of modifications of the first embodiment and the second embodiment will now be described. Modifications of the first and second embodiments are not limited to those described below and any modifications that would enable practice of the present invention are applicable.

Initially, when detecting the relative relationship of the mutually different resonance frequencies of the plurality of reflected waves, two variations can be given as to how each frequency is determined.

The first variation is a method in which, when the frequency is denoted as λ and the intensity of the detected reflected wave is denoted as P, the frequency at which f′(λ) obtained by differentiating once a function P=f(λ) changes from positive to negative is the peak frequency of the reflected wave.

The second variation is a method in which, when the frequency is denoted as λ and the intensity of the detected reflected wave is denoted as P, the center frequency of the frequencies at which f″(λ) obtained by differentiating twice a function P=f(λ) changes from positive to negative is the peak frequency of the reflected wave.

Next, a method of detecting the relative relationship of the mutually different resonance frequencies without using the values of the frequencies is described.

For example, presuming that frequency scans are performed at a constant speed, the times from when a scan is started until peak positions are detected are measured. The measured values are compared with the times from when the scan is started until each peak position is detected or with time differences between the times at which each peak position was detected, making it possible to detect the relative relationship of the mutually different resonance frequencies.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2004-345839 filed Nov. 30, 2004, which is hereby incorporated by reference herein in its entirety.

What is claimed is:

1. A method of reading information from an RF tag that resonates by electromagnetic inductance, the RF tag including at least two sets of electromagnetic resonance circuits having mutually different resonance frequencies, the at least two sets of electromagnetic resonance circuits having at least one of a resistor and a capacitor, a fuse or antifuse element capable of selecting a low impedance state and a high impedance state on the basis of an electrical signal, and a coil antenna, the method comprising:
transmitting a plurality of frequencies to the RF tag;
receiving a plurality of reflected waves corresponding to the mutually different resonance frequencies of the at least two sets of electromagnetic resonance circuits in response to the transmitted plurality of frequencies; and
detecting a relative relationship of the mutually different resonance frequencies of the plurality of reflected waves,
wherein detecting the relative relationship of the mutually different resonance frequencies of the plurality of reflected waves is performed either with or without using the values of the mutually different resonance frequencies.

2. The method of reading information from an RF tag according to claim 1, wherein detection of the relative relationship of the mutually different resonance frequencies of the plurality of reflected waves is performed by detecting a frequency difference between a reference reflected wave corresponding to a resonance frequency of a reference electromagnetic resonance circuit provided in advance in the RF tag and the plurality of reflected waves.

3. The method of reading information from an RF tag according to claim 1, wherein detection of the relative relationship of the mutually different resonance frequencies of the plurality of reflected waves is performed by converting the relationship of the mutually different resonance frequencies of the plurality of reflected waves into an approximate function and comparing the approximate function with a function provided in advance.

4. The method of reading information from an RF tag according to claim 1, wherein detection of the relative relationship of the mutually different frequencies of the plurality of reflected waves is performed by converting the relationship of the mutually different resonance frequencies of the plurality of reflected waves into a graph and comparing the graph with a graph provided in advance.

5. The method of reading information from an RF tag according to claim 1, wherein detecting the relationship of the mutually different resonance frequencies of the plurality of reflected waves without using the values of the mutually different resonance frequencies comprises:
performing at least one frequency scan at a constant speed;
measuring time values from when the at least one frequency scan started until at least one peak position is detected; and
comparing the measured time values with time values from when the at least one frequency scan started until each of the at least one peak position is detected or with time differences between time values at which each of the at least one peak position is detected.

6. A method of writing information into an RF tag that resonates by electromagnetic inductance, the RF tag including at least two sets of electromagnetic resonance circuits having mutually different resonance frequencies, the at least two sets of electromagnetic resonance circuits having at least one of a resistor and a capacitor, a fuse or antifuse element capable of selecting a low impedance state and a high impedance state on the basis of an electrical signal, and a coil antenna, the method comprising:
reading information from the RF tag by measuring the mutually different resonance frequencies of the at least two sets of electromagnetic resonance circuits by transmitting a plurality of frequencies to the RF tag, receiving, in response to the transmitted plurality of frequencies, a plurality of reflected waves corresponding to the mutually different resonance frequencies of the at least two sets of electromagnetic resonance circuits, and detecting a relative relationship of the mutually different resonance frequencies of the plurality of reflected waves; and
irradiating an electromagnetic wave matching a resonance frequency of at least one of the at least two sets of electromagnetic resonance circuits, the irradiated electromagnetic wave having a larger amplitude than an electromagnetic wave associated with the reading of information, in order to change the impedance of the fuse or the antifuse forming the at least one of the at least two sets of electromagnetic resonance circuits so that a resonance frequency of at least one desired electromagnetic wave resonance circuit is changed.

7. The method of writing information into an RF tag according to claim 6, wherein detection of the relative relationship of the mutually different resonance frequencies of the plurality of reflected waves is performed by detecting the frequency difference between a reference reflected wave corresponding to a resonance frequency of a reference electromagnetic resonance circuit provided in advance in the RF tag and the plurality of reflected waves.

8. The method of writing information into an RF tag according to claim 6, wherein detection of the relative relationship of the mutually different resonance frequencies of the plurality of reflected waves is performed by converting the relationship of the mutually different resonance frequencies of the plurality of reflected waves into an approximate function and comparing the approximate function with a function provided in advance.

9. The method of writing information into an RF tag according to claim 6, wherein detection of the relative relationship of the mutually different resonance frequencies of the plurality of reflected waves is performed by converting the relationship of the mutually different resonance frequencies of the plurality of reflected waves into a graph and by comparing the graph with a graph provided in advance.
